(19) United States
(12) Patent Application Publication
(10) Pub. No.: US 2010/0291782 A1
(43) Pub. Date: Nov. 18, 2010

(54) GROMMET FOR ELECTRICAL CONNECTOR AND METHOD OF MANUFACTURING THE SAME

(76) Inventors: Ryan C. Wade, Vestal, NY (US); David O. Gallusser, Oneonta, NY (US)

Correspondence Address: BLANK ROME LLP, WATERGATE, 600 NEW HAMPSHIRE AVENUE, N.W., WASHINGTON, DC, 20037, US

(21) Appl. No.: 12/467,677

(22) Filed: May 18, 2009

(51) Int. Cl. H01R 13/40; B29C 45/14

(52) U.S. Cl. 439/271; 264/272.11

(57) ABSTRACT

A grommet for an electrical connector that comprises a main insulative body that defines a longitudinal axis and at least one inner bore extending through the main insulative body along the longitudinal axis and adapted to receive a wire. The inner bore is defined by a funnel shaped entry area, a contact receiving area opposite the entry area, and an extended longitudinal sealing web that is disposed between the entry area and the contact receiving area. The extended longitudinal sealing web being configured to provide a large surface area for continuous sealing contact with the wire.

### FIELD OF THE INVENTION

The present invention is directed to grommets. More particularly, the present invention relates to grommets that provide protection of electrical wires and other vulnerable materials that pass through solid materials, such as metal sheets.

### BACKGROUND OF THE INVENTION

Oftentimes, it is necessary to cut a hole in metal so that a material (e.g., an electrical wire or cable) can be passed from one side to the other side of the metal. Frequently, that hole has sharp edges, which can damage the materials passing through the metal. For example, electrical wires, cord, rope, lacings, or other soft vulnerable material passing through the hole can become abraded or cut. To avoid such damage, it may be desirable to use a grommet, which shields the wire from damage.

However, many grommets cause unnecessary strain on the delicate materials passing through their centers. In particular, when a wire is required to travel at an angle to go through a connector or a metal sheet, the grommet may damage the wire. Moreover, although conventional connector grommets may include one or more sealing webs, because the webs have a reduced or shortened length, the webs do not provide an effective seal, particularly a water proof seal.

### SUMMARY OF THE INVENTION

Accordingly, the present invention relates to a grommet for an electrical connector that comprises a main insulative body that defines a longitudinal axis. The inner bore is at least one inner bore extending through the main insulative body along the longitudinal axis and adapted to receive a wire. The inner bore is defined by a funnel shaped entry area, a contact receiving area opposite the entry area, and an extended longitudinal sealing web that is disposed between the entry area and the contact receiving area. The extended longitudinal sealing web is configured to provide a large surface area for continuous sealing contact with the wire.

The present invention also relates to a grommet for an electrical connector that comprises a main insulative body, and a plurality of inner bores that extend through the main insulative body. Each of the inner bores extend along a longitudinal axis of the main insulative body and are configured to receive a wire. Each inner bore is defined by a funnel shaped entry area, a contact receiving area opposite the entry area, and an extended longitudinal sealing web disposed between the entry area and the contact receiving area. The extended longitudinal sealing web is configured to provide a large surface area for continuous sealing contact with the wire.

The present invention also relates to an electrical connector that comprises a connector body adapted to support a contact; and a grommet received in the connector body. The grommet includes a main insulative body that defines a longitudinal axis, and at least one inner bore that extends through the main insulative body along the longitudinal axis and adapted to receive a wire. The inner bore is defined by a funnel shaped entry area, a contact receiving area opposite the entry area for receiving the contact, and an extended longitudinal sealing web disposed between the entry area and the contact receiving area. The extended longitudinal sealing web is configured to provide a large surface area for continuous sealing contact with the wire.

The present invention relates to a method of making a grommet for an electrical connector that comprises the steps of injection molding a main body using an elastomer or rubber material, and forming at least one inner bore in the main body such that the inner bore includes a funnel shaped entry area, a contact receiving area opposite the entry area, and an extended longitudinal sealing web disposed between the entry area and the contact receiving area, wherein the extended longitudinal sealing web is shaped to provide a large surface area for continuous sealing contact with a wire.

Other objects, advantages and salient features of the invention will become apparent from the following detailed description, which, taken in conjunction with the annexed drawings, discloses a preferred embodiment of the present invention.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a cross-sectional view of an exemplary multi-hole electrical connector showing a grommet in accordance with a first exemplary embodiment of the present invention;

FIG. 2 is a partial cross-sectional view of the grommet illustrated in FIG. 1;

FIG. 3 is a perspective view of the multi-hole electrical connector illustrated in FIG. 1;

FIG. 4 is a cross-sectional view of the multi-hole electrical connector showing a grommet in accordance with a second exemplary embodiment of the present invention;

FIG. 5 is a partial cross-sectional view of the grommet illustrated in FIG. 4; and

FIG. 6 is a partial cross-sectional view of a grommet according to a third exemplary embodiment of the present invention.

### DESCRIPTION OF THE EMBODIMENTS

The non-limiting embodiments of the present invention will be described hereinafter with reference to the accompanying drawings, wherein like numerals represent like elements.

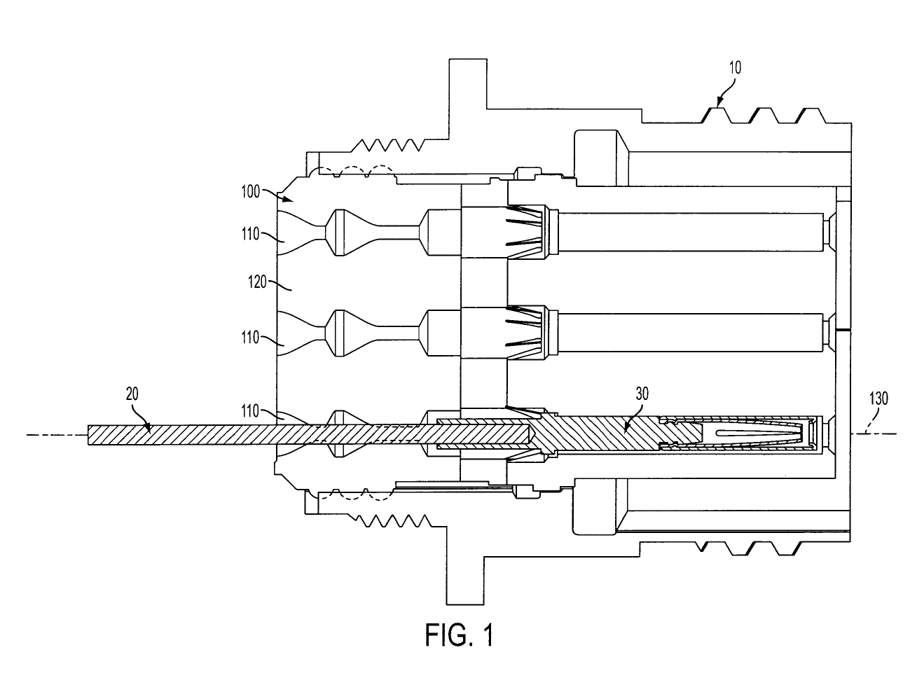

Referring to FIGS. 1-3, a grommet 100 according to first non-limiting embodiment of the present invention may be provided in an electrical connector 10 for receiving one or more wires 20 that couple to a contact 30 of the connector 10. The grommet 100 is designed to provide mechanical protection, as well as water and dust protection to the individual wires 20.

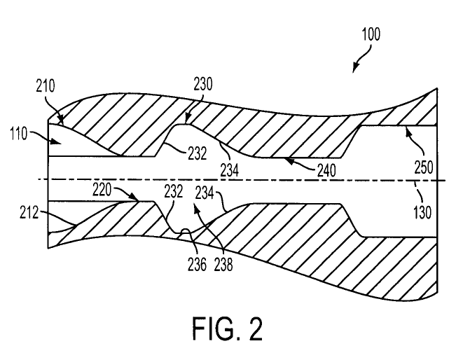

As seen in FIG. 1, the grommet 100 may include a plurality of inner bores 110 extending through its main body 120 along a longitudinal axis 130 thereof. The inner bores 110 are preferably equally spaced from one another. Each inner bore 110 is adapted to receive and seal a respective wire 20, and also adapted to receive the end 32 of a respective contact 30 that is coupled to the wire. As best seen in FIG. 2, each inner bore 110 may include an entry area 210, a longitudinal strain relief web 220, an intermediate area 230, an extended longitudinal sealing web 240 and a contact receiving area 250.

The entry area 210 is preferably funnel shaped to allow for easy installation of the wire 20. The funnel shaped wall 212 of the entry area 210 tapers to the longitudinal strain relief web 220. The strain relief web 220 is a short straight section that provides strain relief to the wire 20, thereby enabling the wire inside to remain straight in the extended longitudinal sealing web 240. The strain relief web 220 also helps maintain the integrity of the extended longitudinal sealing web 240. For example, if the strain relief web 220 is stretched, the extended longitudinal sealing web 240 remains intact, thereby avoiding gaps and leaks.

The strain relief web 220 ends at the intermediate area 230. The intermediate area 230 is generally funnel shaped and extends towards the contact receiving area 250 and away from the entry area 210. The intermediate area 230 may have a plurality of walls including a first ramped wall 232 extending from the strain relief web 220, and a second ramped wall 234 extending toward the sealing web 240. As seen in FIG. 2, the first ramped wall 232 has a slope that is steeper than the second ramped wall 234. Between the first and second ramped walls 232 and 234 is a straight transition wall 236. The walls 232, 234, and 236 define an inner area 238 that can accommodate an installation tool without damage to the grommet 100. The second ramped wall 234 tapers to the extended sealing web 240.

The extended sealing web 240 provides a large surface area that contacts the wire 20 to create a more effective seal than conventional grommets. The sealing web 240 preferably has a diameter that is less than or equal to the diameter of the wire 20. The sealing web 240 also preferably has a smooth continuous surface, that is no ridges or ribs, for sealing contact with the wire. Because the sealing web 240 creates a large surface area for contacting the wire, a water-proof seal is created even where the wire includes irregularities, such as ridges in the insulation of the wire.

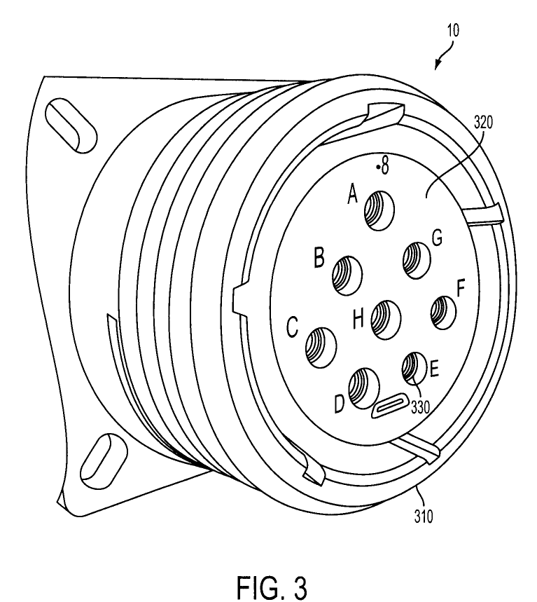

As seen in FIG. 3, the connector 10 in which the grommet 100 is provided may be a multi-hole receptacle that connects to a mating plug (not shown). The receptacle may include a connector body 310 that has a support member 320 with a plurality of holes 330 for supporting the contacts 30. The contacts 30 may be socket-type contacts. Alternatively, the connector 10 may be a plug wherein the contacts 30 are pin-type contacts. Although a multi-hole connector is preferred, the connector 10 can be a single hole connector such that the grommet includes only a single inner bore that receives a single wire.

The grommet 100 may be made by injection molding a rubber or elastomer material. The grommet is preferably made of a flurosilicone rubber. The rubber is injected into a funnel hopper, dumped into a preheater, and into an injection barrel. The rubber is then poured into the mold and is cooled. The mold is then opened and the grommet is ejected.

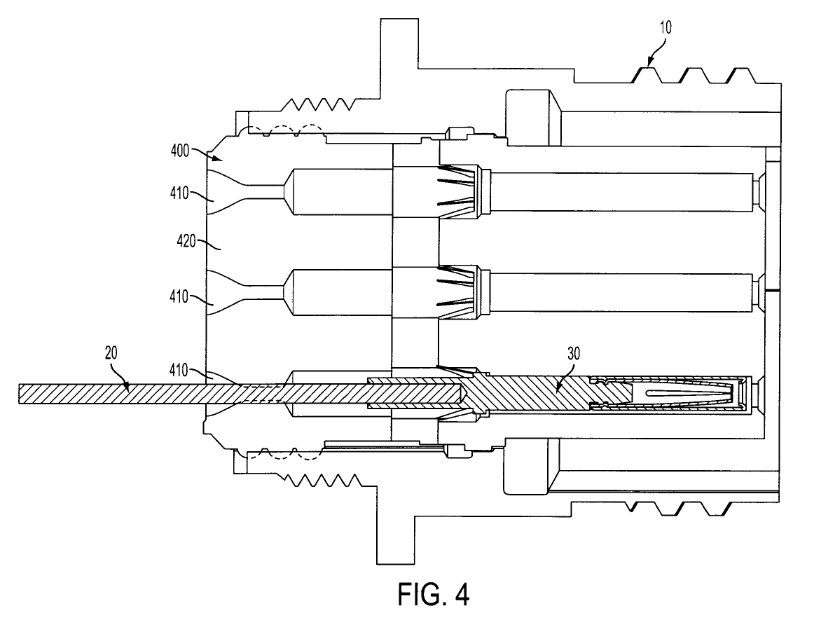

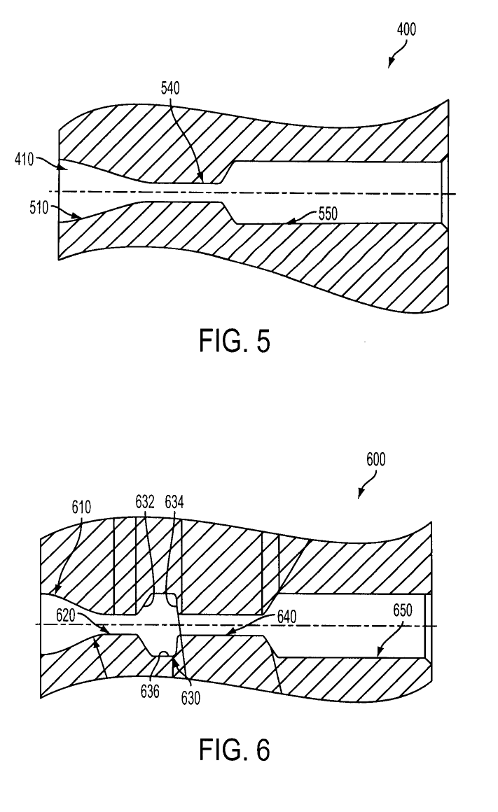

Referring to FIGS. 4 and 5, a grommet 400 according to a second non-limiting embodiment is shown. Like the grommet 100 of the first embodiment, the grommet 400 is located in the connector 10 and includes a plurality of inner bores 410 disposed in the main body 420 for receiving the individual wires 20. Each inner bore 410 is similar to the inner bore 110 of the first embodiment, except that each inner bore 410 includes only a funnel shaped entry area 510, an extended longitudinal sealing web 540 and a contact receiving area 550. The sealing web 540 of the second embodiment is substantially the same as the sealing web 240 of the first embodiment in that it is elongated to provide a large surface area for continuous sealing contact with the wire 20. Due to its single web design, the grommet 400 is easy to manufacture.

Referring to FIG. 6, a grommet 600 according to a third non-limiting embodiment is shown. The grommet 600 is similar to the grommet 100 of the first embodiment in that its inner bore includes an entry area 610, a longitudinal strain relief area 620, an intermediate area 630, an extended longitudinal sealing web 640 and a contact receiving area 650. The intermediate area 630 differs from the intermediate area 230 of the first embodiment in that instead of a second ramped wall, the intermediate area 630 includes a blunt wall 634 that is not ramped. The blunt wall 634 terminates at the extended longitudinal sealing web 640. The blunt wall 634 together with a first ramped wall 632 and a transition wall 636 define an inner area that accommodates an installation tool. The sealing web 640 of the grommet 600 is substantially the same as the sealing web 240 of the first embodiment in that it is elongated to provide a large surface area for continuous sealing contact with the wire 20.

While particular embodiments have been chosen to illustrate the invention, it will be understood by those skilled in the art that various changes and modifications can be made therein without departing from the scope of the invention as defined in the appended claims.

What is claimed is:

1. A grommet for an electrical connector, comprising of:
a main insulative body defining a longitudinal axis; and
at least one inner bore extending through said main insulative body along said longitudinal axis and adapted to receive a wire, said inner bore being defined by:
a funnel shaped entry area;
a contact receiving area opposite said entry area, and
an extended longitudinal sealing web disposed between said entry area and said contact receiving area, said extended longitudinal sealing web being configured to provide a large surface area for continuous sealing contact with the wire.

2. A grommet according to claim 1, wherein
said entry area includes a longitudinal strain relief web; and
said extended longitudinal sealing web being longer than said longitudinal strain relief web.

3. A grommet according to claim 2, wherein
said extended longitudinal sealing web being about twice as long as said longitudinal strain relief web.

4. A grommet according to claim 2, wherein
said inner bore includes an intermediate area disposed between said longitudinal strain relief web and said extended longitudinal sealing web, said intermediate area including a plurality of walls.

5. A grommet according to claim 4, wherein
said plurality of walls of said intermediate area including at least a first ramped wall extending from said longitudinal strain relief web.

6. A grommet according to claim 5, wherein
said intermediate area includes a second ramped wall extending away from said first ramped wall; and
a slope of the first ramped wall being steeper than the slope of the second ramped wall.

7. A grommet according to claim 1, wherein
said extended longitudinal sealing web has a constant diameter that is less than or equal to a diameter of the wire.

8. A grommet according to claim 1, wherein
said extended longitudinal sealing web has a continuous smooth surface for engaging the wire.

9. A grommet for an electrical connector, comprising of:
a main insulative body; and
a plurality of inner bores extending through said main insulative body, each of said inner bores extending along a longitudinal axis of said main insulative body and being configured to receive a wire, and each inner bore being defined by:
a funnel shaped entry area;
a contact receiving area opposite said entry area, and
an extended longitudinal sealing web disposed between said entry area and said contact receiving area, said extended longitudinal sealing web being configured to provide a large surface area for continuous sealing contact with the wire.

10. A grommet according to claim 9, wherein
said plurality of inner bores are substantially equally spaced from one another.

11. A grommet according to claim 9, wherein
said entry area includes a longitudinal strain relief web; and
said extended longitudinal sealing web being about twice as long as said longitudinal strain relief web.

12. A grommet according to claim 11, wherein
each of said inner bore includes an intermediate area disposed between said longitudinal strain relief web and said extended longitudinal sealing web, said intermediate area including at least a first ramped wall.

13. A grommet according to claim 12, wherein
said intermediate area includes a second ramped wall extending away from said first ramped wall; and
a slope of the first ramped wall being steeper than the slope of the second ramped wall.

14. A grommet according to claim 9, wherein
said extended longitudinal sealing web has a constant diameter that is less than or equal to a diameter of the wire.

15. A grommet according to claim 9, wherein
said extended longitudinal sealing web has a continuous smooth surface for engaging the wire.

16. An electrical connector, comprising of:
a connector body adapted to support a contact; and
a grommet received in said connector body, said grommet including,
a main insulative body defining a longitudinal axis; and
at least one inner bore extending through said main insulative body along said longitudinal axis and adapted to receive a wire, said inner bore being defined by:
a funnel shaped entry area;
a contact receiving area opposite said entry area for receiving the contact, and
an extended longitudinal sealing web disposed between said entry area and said contact receiving area, said extended longitudinal sealing web being configured to provide a large surface area for continuous sealing contact with the wire.

17. A grommet according to claim 16, wherein
said entry area includes a longitudinal strain relief web; and
said extended longitudinal sealing web being longer than said longitudinal strain relief web.

18. A grommet according to claim 17, wherein
said extended longitudinal sealing web being about twice as long as said longitudinal strain relief web.

19. A method of making a grommet for an electrical connector, comprising the steps of:
injection molding a main body using an elastomer or rubber material; and
forming at least one inner bore in the main body such that the inner bore includes a funnel shaped entry area, a contact receiving area opposite the entry area, and an extended longitudinal sealing web disposed between the entry area and the contact receiving area, wherein the extended longitudinal sealing web is shaped to provide a large surface area for continuous sealing contact with a wire.

20. A method according to claim 19, further comprising the step of:
forming another inner bore through said main body that is substantially identical to the one inner bore.

21. A method according to claim 19, further comprising the step of:
forming a longitudinal strain relief web in the inner bore, wherein the extended longitudinal sealing web is about twice as long as the longitudinal strain relief web.
